(19) United States
(12) Patent Application Publication
(10) Pub. No.: US 2025/0121551 A1
(43) Pub. Date: Apr. 17, 2025

(54) METHOD OF MANUFACTURING

(71) Applicant: TOYOTA JIDOSHA KABUSHIKI KAISHA, Toyota-shi (JP)

(72) Inventors: Toshinori NAKAKURA, Nagakute-shi (JP); Nobuyuki NAGAI, Toyota-shi (JP); Hajime FURUKAWA, Nisshin-shi (JP); Yuji SASAKI, Toyota-shi (JP)

(73) Assignee: TOYOTA JIDOSHA KABUSHIKI KAISHA, Toyota-shi (JP)

(21) Appl. No.: 18/889,596

(22) Filed: Sep. 19, 2024

(30) Foreign Application Priority Data
Oct. 11, 2023 (JP) 2023-176006

(51) Int. Cl. B29C 51/14; B29C 35/08; B29C 51/26

(52) U.S. Cl. CPC B29C 51/14; B29C 51/266; B29C 2035/0827; B29K 2995/007

(57) ABSTRACT

A method of manufacturing the resin molded product, comprises: (a) applying a resin on the thermoplastic resin sheet to form the resin layer, (b) heating the resin layer; (c) irradiating the resin layer with UV; (d) molding the thermoplastic resin sheet having the resin layer formed thereon; and (e) after (d), irradiating the resin layer with UV. (c) and (b) are performed by the time the molding in (d) is completed.

### CROSS REFERENCE TO RELATED APPLICATIONS

The present application claims the priority based on Japanese Patent Application No. 2023-176006, filed on Oct. 11, 2023, the disclosure of which is hereby incorporated by reference in its entirety.

### BACKGROUND

### Field

The present disclosure relates to a method of manufacturing.

### Related Art

Conventionally, there has been a manufacturing method in which, for a product in which coating is applied to a base material, a base material is molded after coating is applied to a plate-like base material. In the case of this manufacturing method, in the process after coating, pressure is applied to the painted surface, there is a case where traces remain on the painted surface. Therefore, there is a technique for suppressing traces formed when subjected to pressure. For example, JP H05-185030 discloses the pre-coated steel plate with the non-decorative coating surface formed a clear coating film for absorbing the pressure.

However, in the case of a manufacturing method in which coating is applied to a base material and then molded, there is another problem that it is difficult to mold because a coated surface is already formed on a base material in a molding process. Incidentally, these problems are common not only when the base material is a steel plate, even when the base material is a resin sheet.

### SUMMARY

According to one aspect of the disclosure, there is provided a method of manufacturing a resin molded product. The method of manufacturing comprises: (a) applying a resin containing an UV curable resin and a thermosetting resin on a thermoplastic resin sheet to form a resin layer; (b) heating the resin layer so that the thermosetting resin is in a cured state; (c) irradiating the resin layer with UV so that the UV curable resin is in a semi-cured condition; (d) molding the thermoplastic resin sheet having the resin layer formed thereon; and (e) after (d), irradiating the resin layer with UV so that the UV curable resin is in a cured condition; wherein (c) and (b) are performed by the time the molding in (d) is completed.

### BRIEF DESCRIPTION OF THE DRAWINGS

FIG. 1 is a flow chart showing the steps of a resin molded product manufacturing process;

FIG. 2 is a schematic diagram illustrating the steps of the manufacturing process; and

FIG. 3 is a diagram explaining the relation between UV radiation and curing condition of an UV curable resin.

### DETAILED DESCRIPTION

### A. Embodiment

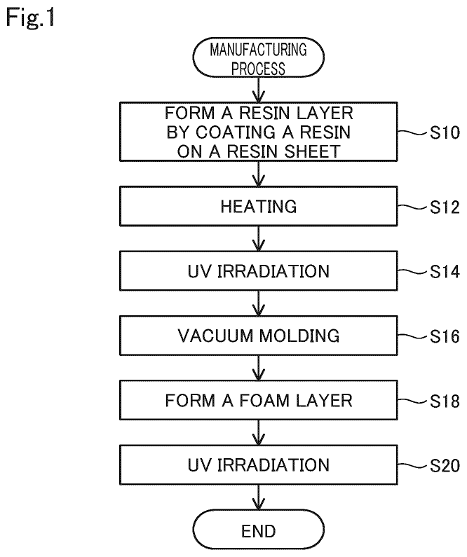

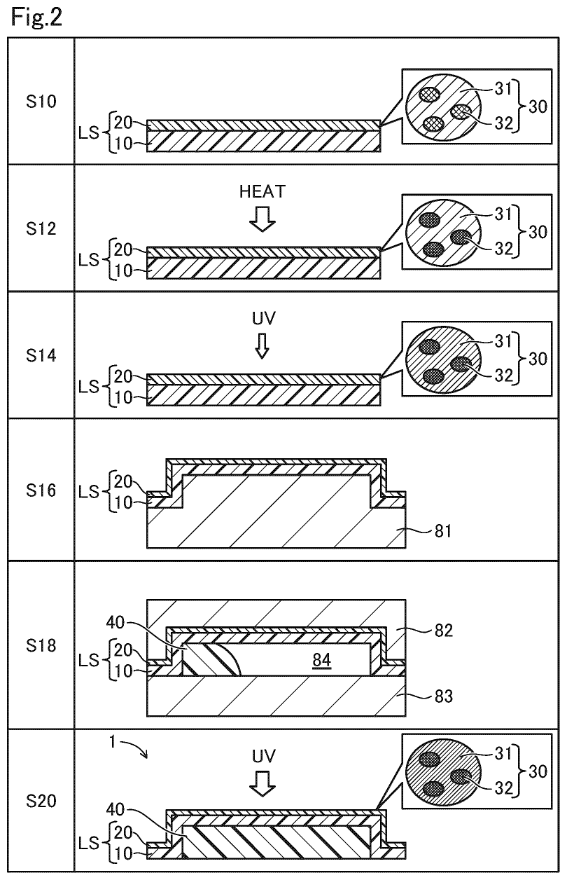

FIG. 1 is a flow chart which shows the procedure of the manufacturing process which realizes the manufacturing process of the resin molded product 1. FIG. 2 is a schematic diagram illustrating each step of the manufacturing process.

As shown in “S20” in FIG. 2, the resin molded product 1 manufactured in the present manufacturing process mainly includes the thermoplastic resin sheet 10 and a resin layer 20 disposed on the thermoplastic resin sheet 10. The resin molded product 1 in the present embodiment is used for interior or exterior of vehicles. The interior of the vehicle is, for example, an automobile seat. By the resin layer 20, it is possible to impart scratch resistance, chemical resistance, and weather resistance to the resin molded product 1.

Incidentally, if a manufacturing process in which the resin layer 20 is made of the thermosetting resin and the resin layer 20 is thermally cured after the thermoplastic resin sheet 10 is molded, a heat oven capable of storing a molded article having a large volume must be prepared. As the heating furnace increases, the energy required for heating increases. Therefore, in this embodiment, prior to molding the thermoplastic resin sheet 10, the resin layer 20 is formed on the thermoplastic resin sheet 10 to cure the resin layer 20. Thus, the heating-furnace for thermosetting the resin layer 20 can be made compact, and the energy consumed can be reduced to reduce CO₂ emission.

For a manufacturing process in which the thermoplastic resin sheet 10 is molded after forming the resin layer 20 on the thermoplastic resin sheet 10, the resin layer 20 also needs to be deformable along the mold. In other words, the resin layer 20 is required to have stretchability. In addition, the resin layer 20 is required to have a hardness such that no marks remain on the resin layer 20 even when a pressure is applied to the resin layer 20 in the process after forming.

The inventors have found that the resin layer 20 can be adjusted to a desired hardness while having stretchability in the resin layer 20 by using a resin 30 containing the UV curable resin 31 and the thermosetting resin 32 as a resin material for forming the resin layer 20, and heating the resin layer 20 prior to molding, and irradiating with UV (ultraviolet rays) so as to have an integrated light amount in a specified range. Then, after molding, it was found that the resin layer 20 can be imparted with appropriate scratch resistance, chemical resistance, and weather resistance by irradiating the resin layer 20 with UV. It will be described in detail below.

Hereinafter, each step of the manufacturing process is described as “S”. In S10 as an applying a resin step of FIG. 1, the thermoplastic resin sheet 10 is applied a resin 30 to form the resin layer 20. In the present embodiment, the thickness of the resin layer 20 is about 5 μm or more and 25 μm or less. As indicated by “S10” in FIG. 2, the resin 30 includes the UV curable resin 31 and the thermosetting resin 32. The thermosetting resin 32 is particulate and scattered in the UV curable resin 31. In this embodiment, the resin 30 is transparent, but a colored resin 30 may be used.

As a material of the thermoplastic resin sheet 10, an AES resin can be used. As the UV curable resin 31, an acrylic resin can be used. As the thermosetting resin 32, an acrylic-urethane resin can be used. In the following explanation, “the thermoplastic resin sheet 10 on which the resin layer 20 is formed” may be described as a “laminated sheet LS” As a device for applying the resin 30 to the thermoplastic resin sheet 10, it is possible to use a roll coater, a slit coater or the like.

In S12 as the heating step of FIG. 1, the laminated sheet LS is heated in a heating furnace so that the thermosetting resin 32 included in the resin layer 20 is in a cured state. In the present embodiment, the heating temperature is about 90° C. or higher 120° C. or less. In this embodiment, the heating time is about 5 minutes or more and 20 minutes or less.

In S14 as the first irradiation step in FIG. 1, so that the UV curable resin 31 included in the resin layer 20 is semi-hardened, UV is irradiated to the laminated sheet LS. Thus, the resin layer 20 can get a stretchability and a hardness to the extent that traces hardly remains when subjected to pressure. Specifically, in S14 of the present embodiment, illuminance of UV is 250 mW/cm². In S14 of the present embodiment, the integrated light amount is 2000 mJ/cm². In the present embodiment, the laminated sheet LS is conveyed. An UV light is used.

In this manufacturing process, there are 2 irradiating UV steps for curing the UV curable resin 31. The 2 steps are S14 and S20 to be described later. Comparing S14 and S20, the integrated light amount of UV in S14 is smaller than the integrated light amount of UV in S20. When the integrated light amount of UV in S14 is A1 [mW/cm²] and the integrated light amount of UV in S20 is A2 [mW/cm²], the equation (1) is satisfied.

$$A 2 / 100 ≦ A 1 ≦ A 2 / 10 \qquad ( 1 )$$

Here, the semi-hardened state is a state before reaching the hardened state. The UV curable resin 31 included in the resin layer 20 changes from an early state with fluidity to a hardened state as the irradiating duration becomes longer when UV with constant illuminance is continuously irradiated. The condition of the UV curable resin 31 can be evaluated at a firmness of the resin layer 20. When the relation between the irradiation time and the hardness is examined, and a state in which the change rate of hardness, which is the change amount of hardness with respect to the unit irradiation time of UV, is equal to or less than the reference value is specified as a hardened state, the semi-hardened state means a state in which the change rate of hardness is greater than the reference value. In this embodiment, the semi-cured state of the UV curable resin 31 is evaluated by the hardness of the resin layer 20. Then, in S14 in which the UV curable resin 31 is brought into a semi-cured state, the condition of irradiating UV is adjusted so that the hardness of the resin layer 20 falls within a predetermined hardness range. Specifically, the hardness range, using Erichsen hardness meter, the reaction force measured when scratching the resin layer 20 after S14 is a range that is 0.3N or more and 1.0N or less.

It is to be noted that the condition of the UV curable resin 31 can also be evaluated by the viscosity of the resin layer 20. As in the case of the hardness described above, when the relationship between the irradiation time and the viscosity is examined and the state in which the change rate of the viscosity, which is the change amount of the viscosity with respect to the unit irradiation time of UV, is equal to or lower than the reference value is defined as the cured state, the semi-cured state refers to a state in which the change rate of the viscosity is larger than the reference value.

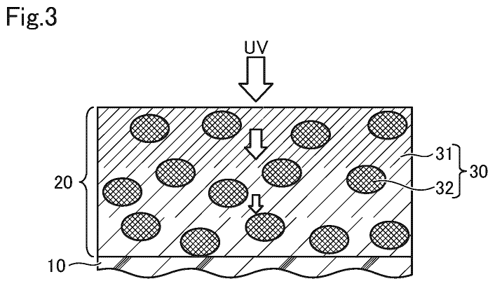

FIG. 3 is a diagram for explaining the relation between UV radiation and the curing condition of the UV curable resin 31 in S14. It is considered that the thermosetting resin 32 inhibits the curing of the UV curable resin 31 when UV is irradiated to the resin 30 containing the thermosetting resin 32 and the UV curable resin 31. Further, it is considered that, among the resin layer 20, the closer to the thermoplastic resin sheet 10, the harder UV is to reach, and the curing is inhibited. As described above, the UV curable resin 31 can be brought into a semi-cured state by using the resin 30 containing not only the UV curable resin 31 but also the thermosetting resin 32. Note that the content ratio of the UV curable resin 31 and the content ratio of the thermosetting resin 32 in the resin 30 are specified and adjusted in advance by experimentation or the like so that a semi-cured state is realized in S12.

Incidentally, the inventors have confirmed that, when the thermosetting resin 32 is not included and the resin layer 20 containing only the UV curable resin 31 is irradiated with UV, it is not easy to bring the resin layer 20 into a semi-cured state even if the illuminance and the irradiation time of UV are limited. In other words, in the present production process, by using the resin 30 containing the thermosetting resin 32 and the UV curable resin 31, it is realized that the resin 30 is brought into a semi-cured state by adjusting the conditions of irradiating UV.

In S16 as molding steps of FIG. 1, by a vacuum-molding method, the laminated sheet LS is molded. Specifically, as shown in “S16” of FIG. 2, the laminated sheet LS containing the thermoplastic resin sheet 10 which is plasticized by heating is disposed on a vacuum mold 81. Afterwards, the inside of the vacuum mold 81 is vacuumed. Thus, the laminated sheet LS is molded along the vacuum mold 81.

As described above, the UV curable resin 31 is in a semi-cured state. In addition, the thermosetting resin 32 of the present embodiment has a property of being deformable by an external force even after curing. Therefore, in S16, the laminated sheet LS can be deformed along the vacuum mold 81. When the deformation of the laminated sheet LS is completed, the laminated sheet LS is cooled until the thermoplastic resin sheet 10 becomes a solidified condition. The laminated sheet LS is then removed from the vacuum mold 81.

In S18 of FIG. 1, a foamed layer 40 is formed. Specifically, the laminated sheet LS after forming an upper mold 82 is fitted. Here, the hardness of the resin layer 20 has a hardness ranging from a predetermined hardness. Therefore, even when the laminated sheet LS is fitted to the upper mold 82, it is suppressed mold marks remain in the resin layer 20.

After the laminated sheet LS is fitted the upper mold 82, the upper mold 82 is placed over a lower mold 83. Between the laminated sheet LS after forming and the lower mold 83, an interior space 84 is formed. Through a flow path (not shown), a foam resin material is injected into the interior space 84. Thus, the interior space 84 is filled with the foam resinous material, and the foamed layer 40 is formed below the laminated sheet LS. In this embodiment, the foamed layer 40 is made of polyurethane foam.

In S20 as the second irradiating step of FIG. 1, the resin layer 20 is irradiated with UV so that the UV curable resin 31 is in a cured condition, and the present manufacturing process is completed.

As described above, the integrated light amount of UV in S20 is greater than the integrated light amount of UV in S14. Specifically, in S20 of the present embodiment, illuminance of UV is 250 mW/cm². In S14 of the present embodiment, the integrated light amount is 2000 mJ/cm². Thus, the UV curable resin 31 is brought into a cured state, and appropriate scratch resistance, chemical resistance, and weather resistance are imparted to the resin molded product 1.

According to the embodiments described above, the manufacturing process of the resin molded product 1 comprises a S10, S12, S14, S16, and a S20. In S10, the resin 30 containing the UV curable resin 31 and the thermosetting resin 32 is applied to the thermoplastic resin sheet 10 to form the resin layer 20 In S12, the resin layer 20 is heated so that the thermosetting resin 32 is cured. In S14, the resin layer 20 is irradiated with UV so that the UV curable resin 31 is semi-cured. S12 and S14 are performed prior to completion of molding the thermoplastic resin sheet 10 in S16. Note that “molding in S16 is completed” means “after the thermoplastic resin sheet 10 is molded, the thermoplastic resin sheet 10 becomes a solidified state by cooling”. By performing S12 and S14, stretchability and desired hardness can be imparted to the resin layer 20. Therefore, in S16, together with the laminated sheet LS can be appropriately molded, even when the laminated sheet LS after molding at S18 is fitted to the upper mold 82, it is possible to make it difficult to leave the mold marks on the resin layer 20.

Further, the integrated light amount of UV in S14 is smaller than the integrated light amount of UV in S20. Further, when the integrated light amount of UV in S14 is A1 [mW/cm²] and the integrated light amount of UV in S20 is A2 [mW/cm²], the equation (1) is satisfied. Thus, in S14, the UV curable resin 31 can be brought into a semi-cured state and in S20, the UV curable resin 31 can be brought into a cured state.

The illuminance of UV in S14 is the same as that of UV in S20. The irradiation time of UV in S14 is shorter than the irradiation time of UV in S20. The integrated light amount of UV in S14 can be made smaller than the integrated light amount of UV in S20.

Also, S12 and S14 are done prior to S16. The resin 30 in an initial state has fluidity. Therefore, prior to forming in a S16, the UV curable resin 31 is brought into a semi-cured state and the thermosetting resin 32 is brought into a cured state. Thus, in S16 to be molded, it is possible to easily handle the laminated sheet LS. S14 is also performed after S12. Thus, in S14, it is possible to inhibit UV to be irradiated by the thermosetting resin 32 in a cured condition.

### B. Other Embodiments

(B1) In the above embodiment, the laminated sheet LS heating S12 is performed prior to UV irradiating S14 on the laminated sheet LS. The order of S12 and S14 is not limited thereto. For example, S14 may be performed prior to S12, and S12 and S14 may be performed in parallel. The thermosetting resin 32 inhibits the irradiated UV even in an early state prior to being in a cured state. Therefore, by using the resin 30, the UV curable resin 31 can be brought into a semi-cured state. In addition, heat for plasticizing the thermoplastic resin sheet 10 in S16 may be used as heat for bringing the thermosetting resin 32 into a cured state. That is, S12 and S16 may be performed in parallel. By the time the forming of the laminated sheet LS is completed, the curing of the thermosetting resin 32 is performed, since the use of a large heating-furnace for heating the molded product of the laminated sheet LS is avoided, it is possible to reduce CO₂ emissions.

(B2) In the above embodiment, the integrated light amount of UV in S14 and the integrated light amount of UV in S20 satisfy the equation (1). The integrated light amount of UV in S14 and the integrated light amount of UV in S20 are not limited thereto. The integrated light amount of UV in S14 and the integrated light amount of UV in S20 may be appropriately set in accordance with the properties of the resin 30.

(B3) In the above embodiment, the illuminance of UV in S14 is the same as the illuminance of UV in S20, and the irradiation time of UV in S14 is shorter than the irradiation time of UV in S20. UV between S14 and S20 is not limited to this. For example, by setting the irradiation time of UV in S14 and the irradiation time of UV in S20 to be the same, the illuminance of UV in S20 may be set to be smaller than the illuminance of the. Also, both the illuminance of UV and the duration of illumination may be set to differ from each other in S14 and S20. In S14, by setting the integrated light amount of UV in S14 to be smaller than the integrated light amount of UV in S20, it is possible to easily adjust the UV curable resin 31 to the semi-cured condition.

(B4) In the above embodiment, the resin molded product 1 includes the foamed layer 40, but the present manufacturing process can be applied to the resin molded product 1 that does not include the foamed layer 40. In the process after S16, the laminated sheet LS is gripped and conveyed, for example, by a robotic system. When gripped, the laminated sheet LS is pressurized. Here, a desired hardness is imparted to the resin layer 20 by S12 and S14. Therefore, even when the pressure is applied by gripping, it is possible to make it difficult to leave a mark gripped by the resin layer 20.

The disclosure is not limited to any of the embodiment and its modifications described above but may be implemented by a diversity of configurations without departing from the scope of the disclosure. For example, the technical features of any of the above embodiments and their modifications may be replaced or combined appropriately, in order to solve part or all of the problems described above or in order to achieve part or all of the advantageous effects described above. Any of the technical features may be omitted appropriately unless the technical feature is described as essential in the description hereof. The present disclosure may be implemented by aspects described below.

(1) According to one aspect of the disclosure, there is provided a method of manufacturing the resin molded product. This method of manufacturing comprises (a) applying a resin containing an UV curable resin and a thermosetting resin on a thermoplastic resin sheet to form a resin layer; (b) heating the resin layer so that the thermosetting resin is in a cured state; (c) irradiating the resin layer with UV so that the UV curable resin is in a semi-cured condition; (d) molding the thermoplastic resin sheet having the resin layer formed thereon; and (e) after (d), irradiating the resin layer with UV so that the UV curable resin is in a cured condition; wherein (c) and (b) are performed by the time the molding in (d) is completed. Therefore, in (d), it is possible to appropriately mold the resin layer formed the thermoplastic resin sheet and to make it difficult to leave a mark even when the resin layer is pressurized in the step after the molding step.

(2) In the method of manufacturing of the above aspect, an integrated light amount of the UV in (c) may be smaller than the integrated light amount of the UV in (e). In the method of manufacturing of this aspect, in (c), the UV curable resin can be brought into a semi-cured state, and in (e), the UV curable resin can be brought into a cured state.

(3) In the method of manufacturing of the above aspect, when the integrated light amount of the UV in (c) is A1 [mW/cm²] and the integrated light amount of the UV in (e) is A2 [mW/cm²], the equation (1) may be satisfied:

$$A 2 / 100 \leq A 1 \leq A 2 / 10 . \qquad ( 1 )$$

In the method of manufacturing of this aspect, in (c), the UV curable resin can be brought into a semi-cured state, and in (e), the UV curable resin can be brought into a cured state.

(4) In the method of manufacturing of the above aspect, illuminance of the UV in (c) may be the same as the illuminance of the UV in (e) and an irradiation time of the UV in (c) may be shorter than the irradiation time of the UV in (e).

(5) In the method of manufacturing of the above aspect, (b) and (c) may be performed before (d). In the method of manufacturing of this aspect, since the resin layer may be brought into a less flowable condition prior to (d), the thermoplastic resin sheet on which the resin layer is formed may be easily handled in (d).

(6) In the method of manufacturing of the above aspect, (c) may be performed after (b). In the method of manufacturing of this aspect, it is possible to inhibit UV in (c) by the thermosetting resin in the cured state to bring the UV curable resin into a semi-cured state.

(7) In the method of manufacturing of the above aspect, a reaction force measured by scratching the resin layer using an Erichsen hardness meter after (c) may be 0.3 N or more and 1.0 N or less. In the method of manufacturing of this aspect, it is possible to impart stretchability and desired hardness to the resin layer.

The disclosure may be implemented by any of various aspects other than those described above: for example, a resin molded product.

What is claimed is:

1. A method of manufacturing a resin molded product, comprising:
(a) applying a resin containing an UV curable resin and a thermosetting resin on a thermoplastic resin sheet to form a resin layer;
(b) heating the resin layer so that the thermosetting resin is in a cured state;
(c) irradiating the resin layer with UV so that the UV curable resin is in a semi-cured condition;
(d) molding the thermoplastic resin sheet having the resin layer formed thereon; and
(e) after (d), irradiating the resin layer with UV so that the UV curable resin is in a cured condition;
wherein (c) and (b) are performed by the time the molding in (d) is completed.

2. The method according to claim 1, wherein an integrated light amount of the UV in (c) is smaller than the integrated light amount of the UV in (e).

3. The method according to claim 2, wherein, when the integrated light amount of the UV in (c) is A1 [mW/cm²] and the integrated light amount of the UV in (e) is A2 [mW/cm²], the equation (1) is satisfied:
$$A 2 / 100 \leq A 1 \leq A 2 / 10 . \qquad ( 1 )$$

4. The method according to claim 2,
wherein illuminance of the UV in (c) is the same as the illuminance of the UV in (e), and
wherein an irradiation time of the UV in (c) is shorter than the irradiation time of the UV in (e).

5. The method according to claim 1, wherein (b) and (c) are performed before (d).

6. The method according to claim 5, wherein (c) is performed after (b).

7. The method according to claim 6, wherein a reaction force measured by scratching the resin layer using an Erichsen hardness meter after (c) is 0.3 N or more and 1.0 N or less.
